(19) United States
(12) Patent Application Publication
(10) Pub. No.: US 2013/0059146 A1
(43) Pub. Date: Mar. 7, 2013

(54) LAMINATED SHEET FOR INTERIOR MATERIAL OF VEHICLE

(71) Applicants: Myoung Ryoul LEE, Hwaseong (KR); Kie Youn JEONG, Suwon (KR); Chun Woo NAM, Daejeon (KR); Hyeong Woo HAN, Chungbuk (KR); Jong Taek NA, Chungbuk (KR)

(72) Inventors: Myoung Ryoul LEE, Hwaseong (KR); Kie Youn JEONG, Suwon (KR); Chun Woo NAM, Daejeon (KR); Hyeong Woo HAN, Chungbuk (KR); Jong Taek NA, Chungbuk (KR)

(73) Assignees: Kia Motors Corporation, Seoul (KR); Hyundai Motor Company, Seoul (KR)

(21) Appl. No.: 13/312,974

(22) Filed: Dec. 6, 2011

(30) Foreign Application Priority Data
Sep. 1, 2011 (KR) 10-2011-0088746

(51) Int. Cl. B32B 5/20; B29C 70/88; B32B 27/32

(52) U.S. Cl. 428/316.6; 156/324

(57) ABSTRACT

The present invention provides a laminated sheet for interior materials of vehicles. The laminated sheet includes a surface layer and an inside layer combined with the surface layer and receiving an injection resin. In particular, the inside layer includes two or more types and foaming ratios of thermoplastic elastomer in a multi-layer.

### CROSS-REFERENCE TO RELATED APPLICATION

This application claims under 35 U.S.C. §119(a) the benefit of Korean Patent Application No. 10-2011-0088746 filed Sep. 1, 2011, the entire contents of which are incorporated herein by reference.

### BACKGROUND

(a) Technical Field

The present invention relates to a laminated sheet, particularly for interior materials of vehicles. More particularly, it relates to a laminated sheet for interior materials of vehicles, which can improve the exterior surface and the perceived quality when injection-molding a resin for manufacturing interior materials of vehicles.

(b) Background Art

Generally, polyvinyl chloride (PVC) and polyvinyl chloride (PVC)/acrylonitrile butadiene styrene (ABS) elastomer alloy extrusion sheets, or calendaring sheets are widely used as surface materials of vehicle interior parts such as instrument panels, door trim panels, and headlinings.

PVC/PO/PP/PE/PU/Cloth are widely used as materials for such sheets, and these sheets are manufactured into desired shapes through vacuum molding, injection molding, and wrapping processes.

In recent years, these sheets have been rapidly replaced with thermoplastic polyolefin-based elastomer (hereinafter referred to as TPO) sheets which are advantageous in their eco-friendliness, lightweight property, and their fogging and smell characteristics.

Vehicle interior surface materials are usually treated using surface treatment agents to improve physical properties such as scratch resistance and abrasion resistance, to improve chemical properties such as chemical resistance and solvent resistance, to provide low luster for preventing interference with a driver's view due to surface reflection, and to improve color matching with other peripheral parts. Since typical TPO sheets have low adherence due to non-polarity and high crystallization, the TPO sheets undergo a chlorinated polyolefin resin-based primer treatment or a surface treatment such as flame treatment, ozone treatment, and plasma treatment, and are then sequentially coated with an acrylic resin-based base coating agent or a urethane resin-based clear coating agent.

However, when resins such as polypropylene (hereinafter also referred to as PP) and TPO are directly injection molded on the inside surface of an interior sheet at a temperature of about 150° C. to manufacture vehicle interior parts, and when the inside layer of the interior sheet has a low heat resistance, rupture and depression may occur in the sheet, or the exterior of the surface layer may be deteriorated (e.g., bending). On the other hand, when the heat-resistance of the inside layer is high, while there is no rupture or depression, the cushion or softness of the surface may be undesirably reduced.

FIG. 1 shows an example of a typical sheet for interior materials of vehicles, which are manufactured by injection-molding resins such as TPO, PVC, and PU. The sheets include a surface layer 10 and an inside layer 20 which is combined with the surface layer 10 onto which resin is injected. The inside layer 20 may be combined with the surface layer 10 using PP foam. When PP foam having a high foaming ratio and a low heat resistance is used as the inside layer 20, the heat resistance may be reduced to cause bending as well as depression and rupture of the PP foam after injection molding, thus deteriorating the exterior surface.

On the other hand, when PP foam having a low foaming ratio and a high heat resistance is used as the inside layer 20, there is no rupture or depression during injection-molding, but the perceived surface quality of the surface layer 10 (e.g. cushion or softness) may be reduced.

Polyethylene foam or thermoplastic olefin foam may be used in the inside layer instead of polypropylene (PP) foam to improve the surface perceived quality. However, this results in an increase in rupture or depression during molding. Also, when cloth is used in the inside layer 20 instead of polypropylene foam, the structure of the surface cloth is transcribed on the surface after the molding, thus deteriorating the exterior surface and reducing the perceived quality.

When a TPO protection film is laminated on an injection surface to prevent rupture or bending of the foam and provide a good perceived quality, the flow of high-temperature resin from the injection gate part may be deteriorated, causing an increase of the surface bending after the injection-molding.

For these reasons, the development of improved layered sheets for interior materials of vehicles is urgently needed. Such sheets should demonstrate excellent surface qualities and perceived qualities after injection-molding, particularly by having an appropriate heat resistance for injection-molding.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a laminated sheet for interior materials of vehicles, which can prevent surface bending, depression, and rupture during injection-molding and which can maximize the perceived surface quality after injection-molding. In particular, the present invention provides a laminated sheet by laminating resin foam of a low foaming ratio and resin foam of a high foaming ratio into a multi-layered structure to thereby maintain heat resistance during fabrication of the sheets for interior materials.

In one aspect, the present invention provides a laminated sheet for interior materials of vehicles including a surface layer and an inside layer combined with the surface layer and which receives an injection resin, wherein the inside layer includes in the multi-layer two or more types and foaming ratios of thermoplastic elastomer.

In an exemplary embodiment, foam of the inside layer may include olefin-based thermoplastic elastomer containing at least one of polypropylene, polyethylene, polypropylene copolymer or terpolymer containing C₂ or C₄˜C₁₂-α-olefins, and polyethylene copolymer or terpolymer containing C₂ or C₄˜C₁₂-α-olefins.

In another exemplary embodiment, the inside layer may contain at least one of styrene-based thermoplastic elastomer, urethane-based thermoplastic elastomer, ester-based thermoplastic elastomer, amide-based thermoplastic elastomer, and vinyl acetate-based thermoplastic elastomer at a suitable content to improve the physical properties (e.g. about 0.1 weight % to about 50 weight %).

In still another exemplary embodiment, the inside layer may have a multi-layered structure including an upper layer and a lower layer, and foam constituting the upper layer may be maintained at a suitable foaming ratio for improvement of perceived quality (e.g., a foaming ratio of about 5 to about 50).

In yet another exemplary embodiment, the inside layer may have a multi-layered structure including an upper layer and a lower layer, and foam constituting the lower layer may be maintained at a suitable foaming ratio for improvement of perceived quality (e.g., a foaming ration of about 1 to about 30).

In still yet another exemplary embodiment, the upper layer and the lower layer may each have a thickness of about 0.5 mm to about 9.5 mm.

In a further exemplary embodiment, a thickness of the inside layer may be maintained at about 1 mm to about 10 mm.

In another further exemplary embodiment, the surface layer may include at least one of thermoplastic olefin sheet, polyvinyl chloride sheet, polyvinyl chloride alloy sheet, and polyurethane sheet.

In still another further exemplary embodiment, the surface layer may include a thermoplastic olefin sheet which may include an olefin-based thermoplastic elastomer containing at least one of polypropylene, polyethylene, polypropylene copolymer or terpolymer containing C₂ or C₄˜C₁₂-α-olefins, and polyethylene copolymer or terpolymer containing C₂ or C₄˜C₁₂-α-olefins and include at least one of styrene-based thermoplastic elastomer, urethane-based thermoplastic elastomer, ester-based thermoplastic elastomer, amide-based thermoplastic elastomer, and vinyl acetate-based thermoplastic elastomer at a suitable content (e.g., about 0.1 weight % to about 50 weight %) to improve physical properties of a sheet. In some embodiments, such a thermoplastic olefin sheet may further undergo an irradiation crosslinking process to improve emboss maintenance and surface abrasion characteristics.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a cross-sectional view illustrating a structure of a typical laminated sheet for interior materials of vehicles; and

FIG. 2 is a cross-sectional view illustrating a structure of a laminated sheet for interior materials of vehicles according to an embodiment of the present invention.

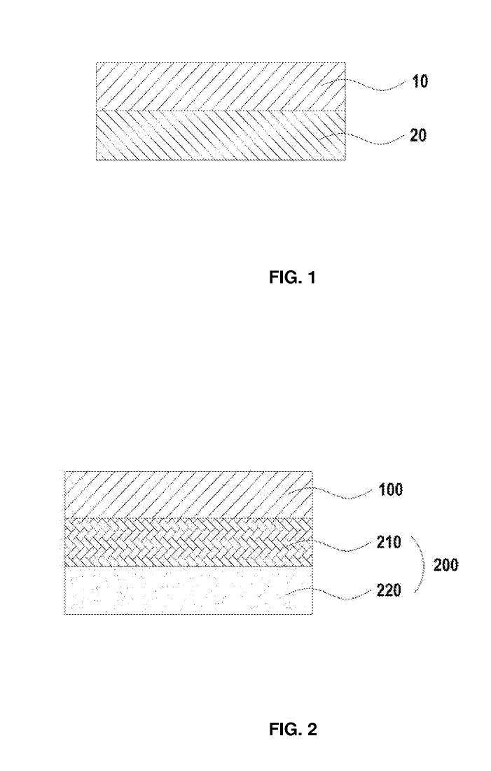

Reference numerals set forth in the Drawings includes reference to the following elements as further discussed below:

| | |
|---|---|
| 100: surface layer | 200: inside layer |
| 210: upper layer | 220: lower layer |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

Hereinafter, exemplary embodiments of the present invention will be described in detail with reference to the accompanying drawings.

FIG. 2 is a cross-sectional view illustrating a structure of a laminated sheet for interior materials of vehicles according to an embodiment of the present invention.

The present invention may maximize the surface perceived qualities, such as cushion or softness, of a laminated sheet for interior materials of vehicles while maintaining heat resistance. Such surface perceived qualities are limited by use of polypropylene (PP) foam having a low foaming ratio, which currently is widely used as an inside layer 200 of a typical laminated sheet for interior materials of vehicles.

A laminated sheet according to an embodiment of the present invention may include a surface layer 100 and an inside layer 200. The inside layer 200 may be formed to have a multi-layer structure, thereby overcoming depression, bending, and rupture of the surface during injection molding and improving the perceived surface qualities such as cushion or softness even after the injection molding. Thus, the surface material 10 can meet both the heat-resistance and the perceived surface qualities which, to date, have been limited in the art.

According to an embodiment of the invention, the inside layer 200 disposed on a side of the surface layer 100 including thermoplastic olefin (TPO) sheets, polyvinyl chloride (PVC) sheets, PVC alloy sheets, and polyurethane sheets may be formed by laminating two or more different types and foaming ratios of olefin polymer-based foam.

In some embodiments, the olefin polymer-based foam which forms the multi-layer surface layer 200 may include olefin-based thermoplastic elastomer (TPE) containing at least one of polypropylene, polyethylene, polypropylene copolymer or terpolymer containing C₂ or C₄˜C₁₂-α-olefins, and polyethylene copolymer or terpolymer containing C₂ or C₄˜C₁₂-α-olefins.

In some embodiments, the olefin polymer-based foam may contain at least one of styrene-based TPE, urethane-based TPE, ester-based TPE, amide-based TPE, and vinyl acetate-based TPE at a suitable content to improve the physical properties of a sheet, such as about 50% or less. Thus, the content could include any value greater than 0% and up to 50% (e.g., from about 0.1%, 0.5%, 1%, 2%, 3%, 4%, etc. ranging up to about 50%).

In various embodiments of the invention, when the inside layer 200 is configured to have multiple layers including an upper layer 210 and a lower layer 220, the lower layer 220 which contacts an injection resin may include foam having a high heat-resistance, while the upper layer 210 which combines with the surface layer 100 may include foam having a better perceived quality (such as cushion and softness) thus positively affecting the perceived quality.

For example, as shown in FIG. 2, the laminated sheet for interior materials of vehicles according to an embodiment of the invention may include the surface layer 100 and the inside layer 200.

In this embodiment, the surface layer 100 may include one of thermoplastic olefin (TPO) sheet, polyvinyl chloride (PVC) sheet, PVC alloy sheet, and polyurethane (PU) sheet, which are commonly used as interior materials of vehicles.

If a TPO sheet is used, the TPO sheet may include olefin-based thermoplastic elastomer (TPE) containing at least one of polypropylene, polyethylene, polypropylene copolymer or terpolymer containing C₂ or C₄˜C₁₂-α-olefins, and polyethylene copolymer or terpolymer containing C₂ or C₄˜C₁₂-α-olefins. The TPO sheet may, in some embodiments, contain at least one of styrene-based TPE, urethane-based TPE, ester-based TPE, amide-based TPE, and vinyl acetate-based TPE at a suitable content to improve the physical properties of a sheet (e.g., about 0.1 weight % to about 50 weight %), and may further undergo an irradiation crosslinking process to improve the emboss maintenance and the surface abrasion characteristic.

In this case, scratch-resistance, durability, chemical-resistance, and abrasion-resistance can be further improved by coating one or more of chlorinated polypropylene (CPP)-based resin, acryl-based resin, and urethane-based resin on the surface of the surface layer 100.

The inside layer 200 may be in the form of a multi-layer, and in some embodiments, may have a multi-layer structure including an upper layer 210 and a lower layer 220.

Of course, the multi-layer is not limited to a two-layer structure, and in various other embodiments the inside layer 200 may have three or more layers, for example, an upper layer, an intermediate layer, and a lower layer.

In particular, when the inside layer 200 is formed in a multi-layer structure, different foaming ratios or types of foam can be used. Since the upper layer 210 is combined with (in contact with) the surface material constituting the surface layer 100, it has an effect on the perceived quality of the surface layer 100. Thus, in order to enhance this perceived quality, the upper layer 210 may be formed using PP/PE/TPO foam for vacuum molding.

Also, since the lower layer 220 contacts a high-temperature injection resin, the lower layer 220 may advantageously be formed using PP foam for injection-molding and like materials, which has an excellent heat-resistance.

Thus, according to an embodiment of the invention, TPE foam may be used as a material of the inside layer 200. In particular, the TPE foam may include an olefin-based thermoplastic elastomer (TPE) containing at least one of polypropylene, polyethylene, polypropylene copolymer or terpolymer containing C₂ or C₄˜C₁₂-α-olefins, and polyethylene copolymer or terpolymer containing C₂ or C₄˜C₁₂-α-olefins. Also, the TPE foam may contain at least one of styrene-based TPE, urethane-based TPE, ester-based TPE, amide-based TPE, and vinyl acetate-based TPE at a suitable content to improve the physical properties of a sheet (e.g., about 50% or less).

In some embodiments, the upper layer 210 may be foamed at a suitable ratio to improve the perceived quality during injection-molding (e.g., about 5 to about 50), and the lower layer 220 may be foamed at a suitable ratio to improve the heat-resistance (e.g., about 1 to about 30).

In addition, the foaming thickness of the upper layer 210 may be suitably provided so as not to affect the surface perceived quality (e.g. a foaming thickness of about 0.5 mm to about 9.5 mm), and the lower layer 220 may also be suitably sized to endure the temperature of injection resin (e.g., a foaming thickness of about 0.5 mm to about 9.5 mm).

The foaming ratio, material type, and thickness of the layers may vary according to the molding condition of the injected resin and the satisfaction of the perceived surface quality. In accordance with certain embodiments, the thickness of the inside layer 200, including the upper layer 210 and the lower layer 220, may range from about 1 mm to about 10 mm.

It is preferred that the thickness of the inside layer 200 is within the above range because when the thickness of one layer is 0.5 mm, that is the minimum maintenance condition when the total thickness of the inside layer 200 is less than about 1 mm. For example, if the upper layer 210 is less than about 0.5 mm, the surface perceived quality may be reduced when the upper layer is combined with the surface material of the surface layer 100. On the other hand, if the lower layer 220 is less than about 0.5 mm, then the temperature (about 150° C. to about 250° C.) of the injected resin negatively impacts the lower layer 220, which may cause bending, depression, and rupture during the injection-molding. Accordingly, the inside layer 200 should have a thickness of about 1 mm or more to avoid these problems.

When the thickness of the inside layer 200 exceeds about 10 mm, a reduction of sharpness of a corner part after molding, deviation from other assemblies, and rise in cost may result. Accordingly, the inside layer 200 should have a thickness of about 10 mm or less to avoid these problems.

On the other hand, in certain embodiments the injection resin may be injected onto a foam surface of a layer sheet, i.e., the undersurface of the inside layer 220 of FIG. 2, through the gate of an injection machine, in a state where the injection resin is melted at a temperature of about 150° C. to about 250° C.

Since the foam cannot be injected in different foam ratios and materials at one time, a separate combining process is required to laminate the different foams. The laminating method may include thermal laminating, adhesive laminating, and hot-melt-type laminating, most preferably, thermal laminating.

When the surface layer 100 is combined with the upper layer 210 of the inside layer 200 through thermal laminating, the temperature of the surface layer 100 directly before the laminating must be suitably maintained at a temperature of least about 50° C. to about 300° C. to prevent foliation after molding.

Hereinafter, the present invention will be described in more detail based on the following embodiment, but the present invention is not limited thereto.

### Example 1

A laminated sheet for interior materials of vehicles according to an embodiment may include a surface layer 100 and an inside layer 200. The surface layer 100 may be configured in accordance with any known method. The inside layer 200 may be manufactured in a structure in which the upper layer 210 is laminated on the lower layer 220. The upper layer 210 is formed of PP/PE/TPO foam material for vacuum molding having a high foaming ratio (e.g., about 15 or more), and the lower layer 220 is formed of PP foam material for injection molding having a lower ratio (e.g., about 15 or less) and a high heat-resistance.

### Test Example 1

The lower layer 220 of the inside layer 200 is formed with the same multilayer structure as Example 1 except that the lower layer is formed of TPO/PP/PE sheets.

### Test Example 2

The inside layer 200 is formed in a single layer structure of PP foam for injection molding, and the surface layer is formed using the same configuration as a typical surface layer.

### Test Example 3

The inside layer 200 is formed in a single layer structure of PP/PE/TPO foam for vacuum molding, and the surface layer is formed using the same configuration as a typical surface layer.

### Test Example 4

The inside layer 200 is formed in a single layer of cloth (e.g., nonwoven, fabric, etc), and the surface layer is formed using the same configuration as a typical surface layer.

In order to check the characteristics of rupture, depression, bending, thickness deviation, and surface perceived quality after injection molding, a sample of the same size and condition was manufactured, and the characteristics were verified during the above process, and the result thereof is expressed as Table 1.

TABLE 1

| | | Rupture/ | Surface | Surface |
|---|---|---|---|---|
| | | depression | exterior | perceived |
| | | during | after | quality |
| | Type of foam | injection | injection | after injec- |
| Division | layer | molding | molding | tion molding |
| Embodiment | Upper layer: | ◯ | ◯ | ◯ |
| | PP/PE/TPO foam | | | |
| | for vacuum | | | |
| | molding | | | |
| Example 1 | Upper layer: | ◯ | X | ◯ |
| | PP/PE/TPO foam | | | |
| | for vacuum | | | |
| | molding | | | |
| Example 2 | PP foam for | ◯ | ◯ | X |
| | injection molding | | | |
| | (high heat- | | | |
| | resistance, | | | |
| | low ratio: | | | |
| | 15 or less) | | | |
| Example 3 | PP/PE/TPO foam | X | X | ◯ |
| | for vacuum | | | |
| | molding (high | | | |
| | ratio: 15 or more) | | | |
| Example 4 | Cloth (nonwoven, | ◯ | X | X |
| | fabric, etc.) | | | |

In table 1, O represents that there are no rupture, depression, surface bending and thickness deviation, and the surface perceived quality is excellent. X means the opposite of O.

As shown in Table 1, the embodiments of the present invention complemented the limitations of typical inside layers 200, and demonstrated excellent injection-molding characteristics (no rupture and depression), surface exterior after the injection molding, and surface perceived quality after the injection molding.

A laminated sheet for interior materials of vehicles according to an embodiment of the present invention has the following advantages.

Depression, rupture, and surface bending do not occur during injection-molding, by configuring an inside layer with two or more different types and foaming ratios of foam in a multi-layered structure, in which the inside layer includes an upper layer of a high foaming ratio contacting a surface layer and a lower layer onto which resin is injected. Accordingly, the exterior of the surface of the laminated sheet can be improved, and the surface perceived quality such as cushion or softness can be improved even after the injection-molding.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

1. A laminated sheet for interior materials of vehicles comprising a surface layer and an inside layer combined with the surface layer, the inside layer receiving an injection resin, wherein the inside layer comprises two or more types and foaming ratios of thermoplastic elastomer in a multi-layer.

2. The laminated sheet of claim 1, wherein thermoplastic elastomer of the inside layer comprises olefin-based thermoplastic elastomer comprising at least one of polypropylene, polyethylene, polypropylene copolymer or terpolymer comprising C₂ or C₄˜C₁₂-α-olefins, and polyethylene copolymer or terpolymer comprising C₂ or C₄˜C₁₂-α-olefins.

3. The laminated sheet of claim 2, wherein the inside layer comprises at least one of styrene-based thermoplastic elastomer, urethane-based thermoplastic elastomer, ester-based thermoplastic elastomer, amide-based thermoplastic elastomer, and vinyl acetate-based thermoplastic elastomer at a content of about 0.1 weight % to about 50 weight % to improve the physical properties.

4. The laminated sheet of claim 2, wherein the inside layer has a multi-layered structure comprising an upper layer and a lower layer, and thermoplastic elastomer constituting the upper layer is maintained at a foaming ratio of about 5 to about 50 for improvement of perceived quality.

5. The laminated sheet of claim 2, wherein the inside layer has a multi-layered structure comprising an upper layer and a lower layer, and thermoplastic elastomer constituting the lower layer is maintained at a foaming ratio of about 1 to about 30 for improvement of perceived quality.

6. The laminated sheet of claim 4, wherein the upper layer and the lower layer each have a thickness of about 0.5 mm to about 9.5 mm.

7. The laminated sheet of claim 1, wherein a thickness of the inside layer ranges from about 1 mm to about 10 mm.

8. The laminated sheet of claim 1, wherein the surface layer comprises at least one of a thermoplastic olefin sheet, polyvinyl chloride sheet, polyvinyl chloride alloy sheet, and polyurethane sheet

9. The laminated sheet of claim 8, wherein the thermoplastic olefin sheet comprises an olefin-based thermoplastic elastomer comprising at least one of polypropylene, polyethylene, polypropylene copolymer or terpolymer comprising C₂ or C₄˜C₁₂-α-olefins, and polyethylene copolymer or terpolymer comprising C₂ or C₄˜C₁₂-α-olefins.

10. The laminated sheet of claim 9, wherein the thermoplastic olefin sheet comprises at least one of styrene-based thermoplastic elastomer, urethane-based thermoplastic elastomer, ester-based thermoplastic elastomer, amide-based thermoplastic elastomer, and vinyl acetate-based thermoplastic elastomer at a content of about 0.1 weight % to about 50 weight % to improve physical properties of a sheet.

11. The laminated sheet of claim 10, wherein the thermoplastic olefin sheet has undergone an irradiation crosslinking process to improve emboss maintenance and surface abrasion characteristics.

12. A vehicle interior part comprising the laminated sheet of claim 1 as a surface material.

13. A method for forming a laminated sheet for interior materials of vehicles comprising forming a multi-layered inside layer of two or more types and foaming ratios of thermoplastic elastomer, combining the inside layer with a surface layer, and receiving on the inside layer an injection resin.
